(19) United States
(12) Patent Application Publication
(10) Pub. No.: US 2013/0028132 A1
(43) Pub. Date: Jan. 31, 2013

(54) METHOD AND ELECTRONIC DEVICE FOR COMMUNICATION TRAFFIC MANAGEMENT

(71) Applicant: Woosik CHOI, Seoul (KR)

(72) Inventor: Woosik CHOI, Seoul (KR)

(21) Appl. No.: 13/191,959

(22) Filed: Jul. 27, 2011

(51) Int. Cl. H04L 12/28

(52) U.S. Cl. 370/254

(57) ABSTRACT

An electronic device and method, including: a communication module, a display, and a controller configured to: obtain information about data communication carried out in a network through the communication module from the network providing multimedia services; and display a plurality of multimedia devices connected to the network and connectivity relationship among the multimedia devices according to the data communication through the display, the connectivity relationship being related to at least one of the multimedia devices communicating multimedia data with at least one other multimedia device.

### BACKGROUND

1. Field

The following description relates to a method for managing communication traffic of a network and an electronic device carrying out the method. More specifically, the following description relates to a method for displaying relationship among multimedia devices according to data communication carried out in a network and managing communication traffic by controlling the data communication; and an electronic device carrying out the method.

2. Related Art

A multimedia service such as N-screen or Digital Living Network Alliance® (DLNA) relying on a plurality of multimedia devices is getting popular. Such a multimedia service causes communication among devices, where the communication is usually caused by contents streaming. If communication is carried out among multiple devices, service quality may be degraded occasionally due to communication traffic of a network; due to this reason, research for resolving the situation above is actively conducted.

### SUMMARY

One objective of the present invention is to provide a method for communication traffic management displaying connectivity relationship among multimedia devices due to data communication to help a user recognize data communication carried out in a network and an electronic device carrying out the method.

Another objective of the present invention is to provide a method for communication traffic management controlling data communication carried out in a network for the user to control communication traffic in the network and an electronic device carrying out the method.

Objects of the present invention are not limited to those described above but other objects not mentioned above would be clearly understood by those skilled in the art to which the present invention belongs from the description provided below.

An electronic device according to one aspect of the present invention comprises a communication module; a display; and a controller obtaining information about data communication carried out in a network through the communication module from the network providing multimedia services and displaying a plurality of multimedia devices connected to the network and connectivity relationship among the multimedia devices according to the data communication through the display.

An electronic device according to another aspect of the present invention comprises a communication module; a display; and a controller obtaining information about data communication carried out in a network through the communication module from the network providing multimedia services and displaying a plurality of multimedia devices connected to the network and connectivity relationship among the multimedia devices according to the data communication through the display. At this point, the controller receives information about the data communication from a network manager managing the network or each of multiple multimedia devices through the communication module.

An electronic device according to yet another aspect of the present invention comprises a communication module; a display; and a controller obtaining information about data communication carried out in a network through the communication module from the network providing multimedia services and displaying a plurality of multimedia devices connected to the network and connectivity relationship among the multimedia devices according to the data communication through the display. At this point, the controller displays the connectivity relationship by using graphic links connecting transmitter-side multimedia devices and receiver-side multimedia devices of the data communication through the display; and the graphic link connecting the multimedia devices reflects at least one of progress status indicating either progress or suspension of the data communication; and progress direction.

An electronic device according to still another aspect of the present invention comprises a communication module; a display; and a controller obtaining information about data communication carried out in a network through the communication module from the network providing multimedia services and displaying connectivity relationship among a plurality of multimedia devices connected to the network and multimedia devices according to the data communication. At this point, the controller displays the connectivity relationship through the display by using graphic links connecting transmitter-side multimedia devices and receiver-side multimedia devices of the data communication through the display, the graphic link connecting multimedia devices reflecting at least one of progress status indicating either progress or suspension of the data communication; and progress direction. Also, the controller displays at least one of speed, priority, communication traffic status, communication type of the data communication, time elapsed for the data communication, and estimated time up to completion of the data communication through the display. In addition, regarding contents communicated according to the data communication, the controller displays at least one of a title of the contents; identification information including at least one of a file name and a representative image of the contents; resolution of the contents; total size of the contents; size of the contents transmitted; total playing time of the contents; and current playing time and playing time corresponding to the size of the contents transmitted.

An electronic device according to a further aspect of the present invention comprises a communication module; a display; and a controller obtaining information about data communication carried out in a network through the communication module from the network providing multimedia services and displaying connectivity relationship among a plurality of multimedia devices connected to the network and multimedia devices according to the data communication. At this point, the controller controls progress or suspension of the data communication; replaces either of a transmitter-side multimedia device and a receiver-side multimedia device of the data communication with another multimedia device; or controls at least one of execution order and maximum communication speed of the data communication.

An electronic device according to a still further aspect of the present invention comprises a communication module; a display; and a controller obtaining information about data communication carried out in a network through the communication module from the network providing multimedia services and displaying connectivity relationship among a plurality of multimedia devices connected to the network and multimedia devices according to the data communication. At this point, the controller further displays connectivity relationship among a contents server external to the network and the multiple multimedia devices through the display, displaying communication traffic caused by data communication among the contents server and the multiple multimedia devices separately or by summing the separate communication traffic.

An electronic device according to yet another aspect of the present invention comprises a communication module; a display; and a controller configured to: obtain information about data communication carried out in a network through the communication module from the network providing multimedia services; and display a plurality of multimedia devices connected to the network and connectivity relationship among the multimedia devices according to the data communication through the display, the connectivity relationship being related to at least one of the multimedia devices communicating multimedia data with at least one other multimedia device.

A method for communication traffic management according to one aspect of the present invention comprises obtaining, from a network providing a multimedia service, information about data communication carried out in the network; and displaying connectivity relationship among a plurality of multimedia devices connected to the network and multimedia devices according to the data communication.

A method for communication traffic management according to another aspect of the present invention comprises obtaining, from a network providing a multimedia service, information about data communication carried out in the network; and displaying connectivity relationship among a plurality of multimedia devices connected to the network and multimedia devices according to the data communication. At this point, when communication resources for data communication carried out in the network are insufficient or when a multimedia device carrying out the data communication is requested to carry out different data communication, the displaying step is carried out.

A method for communication traffic management according to yet another aspect of the present invention comprises obtaining, from a network providing a multimedia service, information about data communication carried out in the network; and displaying connectivity relationship among a plurality of multimedia devices connected to the network and multimedia devices according to the data communication. At this point, information about the data communication is received from a network manager managing the network or each of the multiple multimedia devices.

A method for communication traffic management according to still another aspect of the present invention comprises obtaining, from a network providing a multimedia service, information about data communication carried out in the network; and displaying connectivity relationship among a plurality of multimedia devices connected to the network and multimedia devices according to the data communication. At this point, the connectivity relationship is displayed by using graphic links connecting transmitter-side multimedia devices and receiver-side multimedia devices of the data communication, the graphic link connecting the multimedia devices reflecting progress status representing either progress or suspension of the data communication; and progress direction. Also, at this point, further comprised is at least one of displaying at least one of speed, priority, communication traffic status, communication type of the data communication, time elapsed for the data communication, and estimated time up to completion of the data communication; and displaying at least one of a title of the contents communicated according to the data communication, identification information including at least one of a file name and a representative image of the contents, resolution of the contents, total size of the contents, size of the contents transmitted, total playing time of the contents, and current playing time and playing time corresponding to the size of the contents transmitted.

A method for communication traffic management according to a further aspect of the present invention comprises obtaining, from a network providing a multimedia service, information about data communication carried out in the network; and displaying connectivity relationship among a plurality of multimedia devices connected to the network and multimedia devices according to the data communication, further comprising controlling data communication carried out in the network. At this point, the controlling step comprises at least one of controlling progress or suspension of the data communication; replacing either of a transmitter-side multimedia device and a receiver-side multimedia device of the data communication with another multimedia device; and controlling at least one of execution order and maximum communication speed of the data communication.

A method for communication traffic management according to yet another aspect of the present invention comprises obtaining, from a network providing a multimedia service, information about data communication carried out in the network; and displaying connectivity relationship among a plurality of multimedia devices connected to the network and multimedia devices according to the data communication, the connectivity relationship being related to at least one of the multimedia devices communicating multimedia data with at least one other multimedia device.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 illustrates structure of a network according to an embodiment of the present invention.

FIG. 2 illustrates a network manager according to an embodiment of the present invention.

FIG. 3 illustrates a network and an external network according to an embodiment of the present invention.

FIG. 4 illustrates structure of an electronic device according to an embodiment of the present invention.

FIG. 5 illustrates a flow diagram of a method for communication traffic management according to an embodiment of the present invention.

FIGS. 6 and 7 illustrate occurrence of predetermined events of a method for communication traffic management according to an embodiment of the present invention.

FIGS. 8 to 10 illustrate display of a multimedia device connected to a network of a method for communication traffic management according to an embodiment of the present invention.

FIGS. 11 to 14 illustrate display of connectivity relationship among multimedia devices of a method for communication traffic management according to an embodiment of the present invention.

FIG. 15 illustrates display of information about contents communicated and data communication of a method for communication traffic management according to an embodiment of the present invention.

FIG. 16 illustrates display of communication traffic according to multiple data communication of a method for communication traffic management according to an embodiment of the present invention.

FIGS. 17 and 18 illustrate progress or suspension of data communication of a method for communication traffic management according to an embodiment of the present invention.

FIG. 19 illustrates replacement of a multimedia device carrying out data communication of a method for communication traffic management according to an embodiment of the present invention.

FIGS. 20 and 21 illustrate execution order of carrying out data communication and control of maximum communication speed of a method for communication traffic management according to an embodiment of the present invention.

### DETAILED DESCRIPTION OF THE INVENTION

Terminologies used in this document have been introduced for convenience of description of embodiments of the present invention; embodiments of the present invention are not limited by the terminologies used in this document.

Among the terminologies used in this document, “connection” or “link” does not necessarily imply only direct connection or link, which is a concept including indirect connection or link through an interconnecting object. Also, “module” or “unit” is introduced for convenience of description and does not carry an inherent meaning or function distinguished from each other.

The present invention can be modified or changed without escaping technical principles and scope of the present invention. Modification or change without escaping technical principles and scope of the present invention should be clearly understood by those skilled in the art to which the present invention belongs; therefore, the present invention can include modified or changed examples which do not escape technical principles and scope of the present invention. Therefore, the present invention is not limited by embodiments described later.

In what follows, the present invention will be described with reference to appended drawings. The appended drawings have been introduced to help understand the present invention and technical principles of the present invention are not limited by the appended drawings. For description of the present invention, the same constituting element refers to the same drawing symbol and repeated description can be omitted.

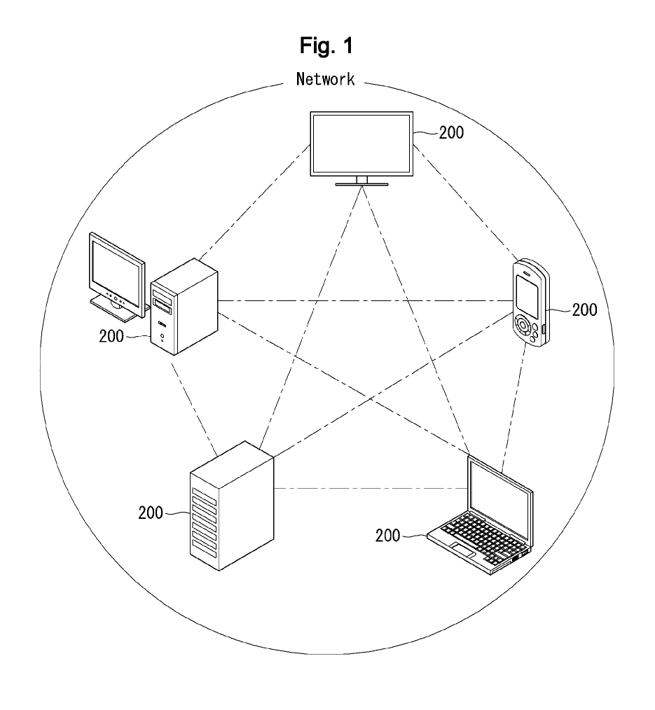

In what follows, a network according to an embodiment of the present invention will be described with reference to FIGS. 1 to 3.

A network according to an embodiment of the present invention can provide a multimedia service.

FIG. 1 illustrates structure of a network according to an embodiment of the present invention. As shown in FIG. 1, a network can comprise a plurality of multimedia devices 200.

At this point, a multimedia device 200 refers to a device carrying out a service related to multimedia, which can classified into a contents player playing or executing contents and a contents source storing contents and providing stored contents to a contents player. At this point, the contents player and the contents source are not physically distinguished; therefore, the two can be realized in the same multimedia device 200.

At this point, contents refers to multimedia contents; multimedia contents can include moving images such as movies, still images such as photographs, audio such as music, documents such as e-books, and webpages.

A contents player can play or execute the contents above. At this point, the contents player can execute contents stored in a storage area inside the device or execute contents by receiving the contents from the outside. Also, a contents source can store contents and transmit its retaining contents to a contents player or to another contents source.

A contents player can refer to TV, monitor, PC, smart phone, tablet, MP3 player, PDA, and the like while a contents source PC, NAS (Network Attached Storage), and the like. For example, a smart phone can receive a movie file from a NAS and play the received file.

As described above, in order for a network according to an embodiment of the present invention to provide a multimedia service, data communication should be carried out among multimedia devices 200.

Multimedia devices 200 can be connected to each other through a communication network; multimedia devices 200 can be connected to each other through a short range wireless communication network or through a wired communication network. Short range communication network, for example, can be carried out according to such communication specifications as Wi-Fi, Zigbee, Bluetooth, NFC (Near-Field Communication), and so on while wired communication may be according to LAN.

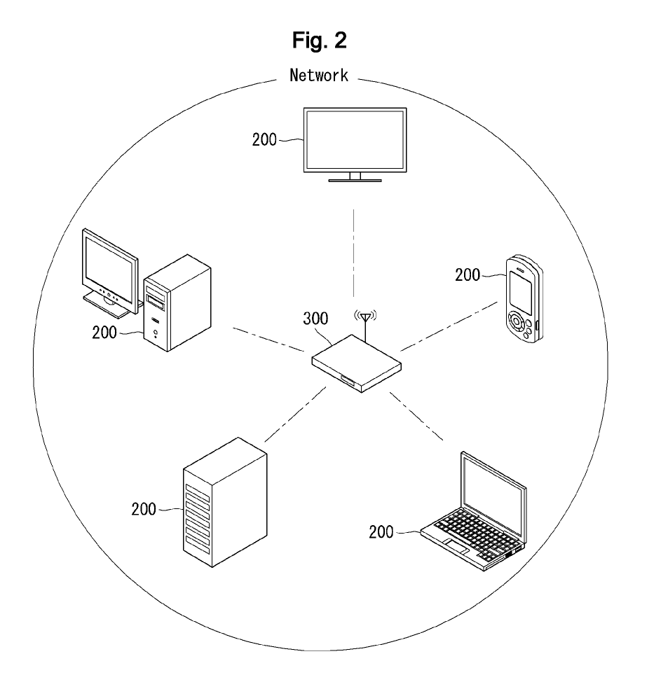

The network can have a network manager 300 for managing various multimedia devices 200 connected to the network. FIG. 2 illustrates a network manager 300 according to an embodiment of the present invention.

A network manager 300 is a device managing a network, capable of managing addresses of multimedia devices 200 connected to a network, monitoring operation of the devices, or controlling the devices. More specifically, the network manager 300, if a multimedia device 200 connects to a network, can assign an address to the multimedia device 200 and manages the address. Also, the network manager 300 can detect data communication carried out among multimedia devices 200. In addition, the network manager 300, by transmitting a control signal to a multimedia device 200, can control operation of the multimedia device 200.

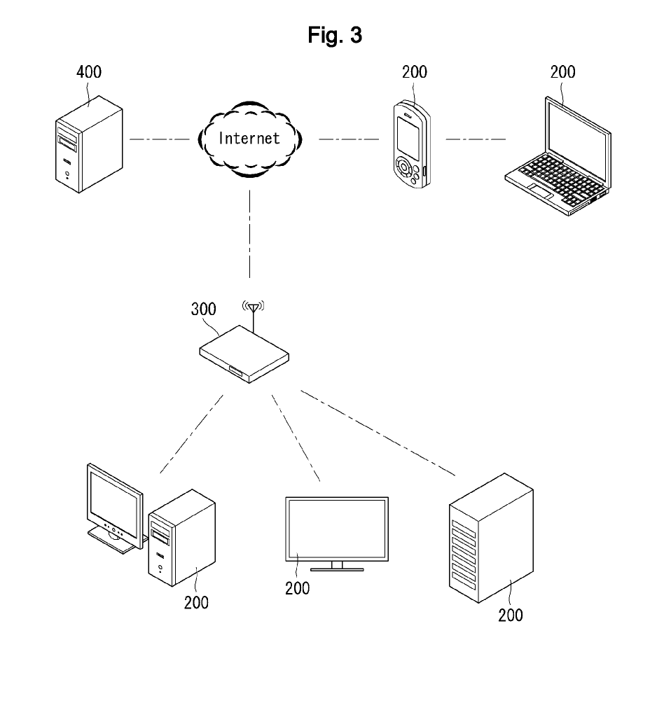

The network according to an embodiment of the present invention can provide a multimedia service in association with an external network. FIG. 3 illustrates a network and an external network according to an embodiment of the present invention.

A network can be connected to an external network such as the Internet. By doing so, a multimedia device 200 connected to the network can obtain contents from the external network.

A network can be connected to an external network through a gateway. Each multimedia device 200 can connect to an external network through a gateway; for example, a multimedia device 200 such as PC or IPTV can connect to the Internet via wired LAN through a gateway.

Similarly, each of multimedia devices 200 connected to a network can connect directly to an external network. For example, multimedia devices 200 such as smart phones can connect directly to the Internet through a mobile communication network.

Also, multimedia devices 200 included in a network can connect to an external network through a multimedia device 200 capable of connecting directly to the aforementioned network. For example, a notebook computer can connect to the Internet by tethering a smart phone via Wi-Fi, which is connected to the Internet through a mobile communication.

As described above, if a network is connected to an external network, a multimedia device 200 included in a network can receive contents from a contents server 400 in an external network. At this point, a contents server 400, being located outside the network, provides contents to a multimedia device 200 inside the network. Such a contents server 400 may include a web hard drive or a cloud server on the Internet.

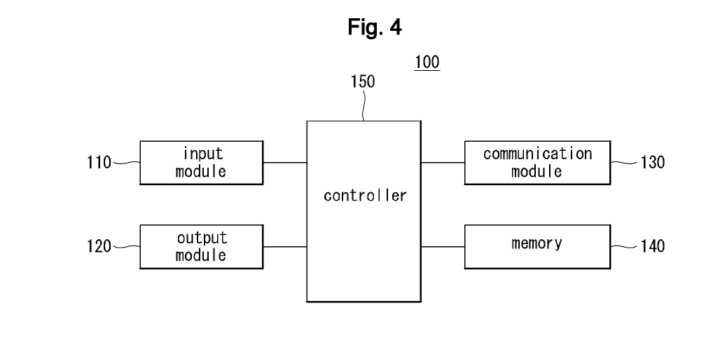

In what follows, an electronic device 100 carrying out a method for communication traffic management according to an embodiment of the present invention will be described with respect to FIG. 4.

An electronic device 100 according to an embodiment of the present invention can manage communication traffic of the network described above. To be specific, an electronic device 100, by connecting to the aforementioned network, can obtain information about data communication carried out in the network, provide the obtained information for the user, and manage communication traffic of the network by controlling data communication of multimedia devices.

An electronic device 100 according to an embodiment of the present invention can include a mobile communication terminal, a mobile phone, a smart phone, PDA (Personal Digital Assistant), PMP (Portable Multimedia Player), a laptop computer, a tablet computer, and the like; it is also possible for any one of the aforementioned multimedia devices 200 to perform the role of the electronic device 100.

FIG. 4 illustrates structure of an electronic device 100 according to an embodiment of the present invention.

An electronic device 100 according to an embodiment of the present invention can comprise an input module 110 receiving inputs, an output module 120 outputting information, a communication module 130 carrying out communication, a storage unit 140 storing information, and a controller 150 controlling overall operation of the electronic device 100. It should be noted that the aforementioned elements are not necessarily required for the electronic device 100 according to an embodiment of the present invention; therefore, the electronic device 100 can include the aforementioned elements selectively.

In what follows, each element of the electronic device 100 according to an embodiment of the present invention will be described.

The input module 110 can receive inputs. The user can control the operation of the electronic device 100 directly through the input module 110.

The input module 110 can include at least one of a keyboard, a keypad, a dome switch, a jog wheel, and a touch pad.

The output module 120 can output information. The user can receive various kinds of information from the electronic device 100 through the output module 120.

The output module 120 can output information by using a visual, aural, and tactile signal. The output module 120 can include at least one of output means such as a display, a speaker, and a vibrator.

A display can display information processed in an electronic device. The display can be implemented by at least one of display means such as liquid crystal display (LCD), field emission display (FED), plasma display panel (PDP), organic light emitting display (OLED), thin film transistor liquid crystal display, flexible display, 3D display, etc.

Meanwhile, the output module 120 can be implemented in the form of a single device in conjunction with the input module 110. For example, the input module 110 and the output module 120 can be implemented as a touch screen which receives touch signals while displaying images.

The communication module 130 can carry out communication. The communication module 130, by carrying out communication with an external device, can transmit and receive various kinds of information. The communication module 130 can be implemented by including at least one of an Internet module, a short range communication module, and a wired communication module.

The Internet module is a device transmitting and receiving information by connecting to the Internet through wired or wireless communication. The Internet module can transmit and receive various kinds of information by connecting to the Internet. The Internet module can be realized in the form of an embedded module inside an electronic device 100, a separate module outside thereof, or a detachable module.

The Internet module can connect to the Internet through wired or wireless communication and carry out communication according to various kinds of communication specifications such as LAN (Local Area Network), WLAN (wireless LAN), Wibro (wireless broadband), Wimax (world interoperability for microwave access), and HSDPA (High Speed Downlink Packet Access).

The short range communication module can carry out short range wireless communication.

The short range communication module can carry out communication according to at least one of short range communication specifications such as Bluetooth, RFID (radio frequency identification), IrDA (infrared data association), UWB (ultra wideband), Zigbee, NFC (near field communication), and other short range communication specifications.

The short range communication module can communicate with various types of external devices at short range; for example, an electronic device 100 can remotely control nearby multimedia devices 200 through the short range communication module. To give another example, the electronic device 100 can connect to the Internet indirectly through an Internet-enabled external device by using the short range communication module.

The wired communication module can connect an electronic device 100 with an external device through wired communication.

The wired communication module can carry out communication with an external device through various types of interfaces. A USB (universal serial bus) port, RS-232 port, a headset, an external charger port, a memory card port, an audio input/output port, a video input/output port, or an earphone jack can be used to implement the interface.

Meanwhile, the communication module 130 does not necessarily have to carry out communication by using only a single communication module; depending on a situation, a plurality of communication modules can be involved to carry out multiple types of communication at the same time.

The storage unit 140 can store information.

The storage unit 140 can store information required for operation of an electronic device 100 and information generated by operation of the electronic device 100. Information required for operation of an electronic device 100 can include OS (operating system), an application for carrying out a method for traffic management, and so on. Also, the information generated by operation of the electronic device 100 can include, for example, a control signal for controlling data communication of a multimedia device 200.

The storage unit 140 can include various types of storage media. For example, the storage unit 140 can be implemented by using at least one of flash memory, RAM (random access memory), SRAM (static random access memory), ROM (read only memory), EEPROM (electrically erasable programmable read only memory), hard disk, magnetic memory, magnetic disc, optical disc such as CD, DVD, or Blu-ray, and card-type memory such as an SD card.

The storage unit 140 can be realized in the form of an embedded module inside an electronic device 100, a separate module outside thereof, or a detachable module. The storage unit 140 in the form of separate module outside an electronic device can include a web storage carrying out a storage function of the storage unit 140 on the Internet as well as an external hard disc.

The controller 150 can control the overall operation of an electronic device 100 and other parts of the electronic device 100. For example, the controller 150 can associate various kinds of information and process the information for further use.

The controller 150 can be implemented in the form of software, hardware, a computer incorporating a combination of the software and hardware, or a device similar to the above.

Hardware form of the controller 150 can be implemented by using at least one of control means such as ASICs (application specific integrated circuits), DSPs (digital signal processors), DSPDs (digital signal processing devices), PLDs (programmable logic device), FPGAs (field programmable gate arrays), processors, controllers, micro-controllers, and microprocessors.

Also, software form of the controller 150 can be implemented by software codes written by more than on programming language or a software application. The software can be stored in the storage unit 140 and can be executed by the hardware structure of the controller 150. In addition, the software can be installed in the electronic device 100 as it is transmitted to the electronic device 100.

The operation carried out by the controller 150 will be described later in the description about a method for path planning according to an embodiment of the present invention.

In what follows, a method for communication traffic management according to an embodiment of the present invention will be described.

A method for communication traffic management according to an embodiment of the present invention will be described by using a network and an electronic device 100 according to an embodiment of the present invention. At this point, to describe a method for communication traffic management according to an embodiment of the present invention by relying on a network and an electronic device 100 according to an embodiment of the present invention is only for the purpose of convenience of description; not to mention a network and an electronic device 100 according to an embodiment of the present invention, a method for communication traffic management according to an embodiment of the present invention can be carried out by using a different network and a different electronic device carrying out the same or a similar function thereof.

Therefore, the scope of appended claims regarding a method for communication traffic management according to an embodiment of the present invention is not limited by a network and an electronic device according to an embodiment of the present invention.

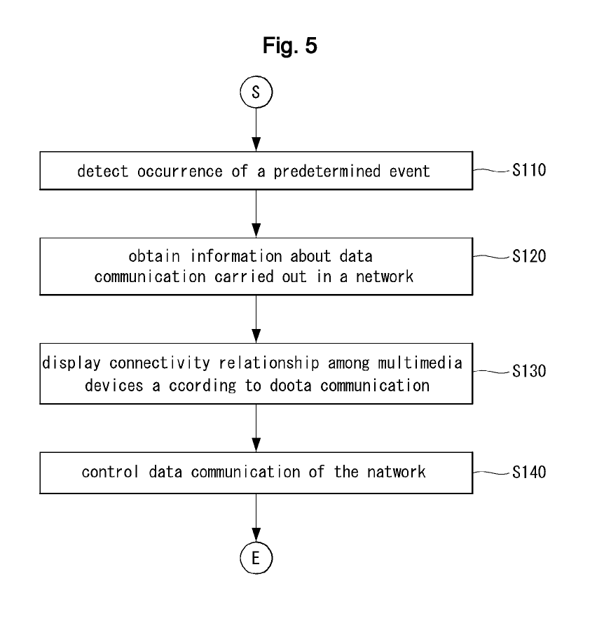

FIG. 5 illustrates a flow diagram of a method for communication traffic management according to an embodiment of the present invention.

A method for communication traffic management according to an embodiment of the present invention can comprise at least one of detecting occurrence of predetermined events S110, obtaining information about data communication carried out in a network S120, displaying connectivity relationship among multimedia devices 200 according to data communication S130, and controlling data communication of the network S140.

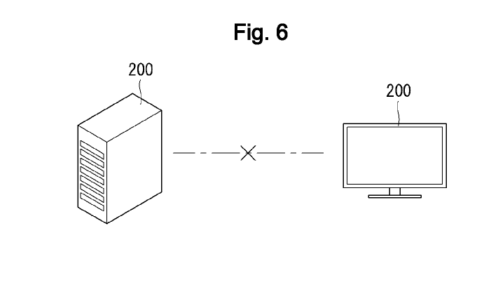

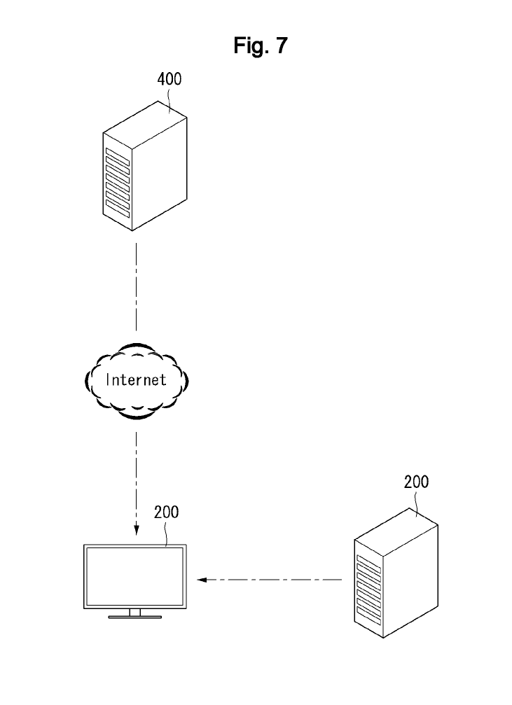

An electronic device 100 can detect occurrence of a predetermined event S110. The current step will be described with reference to FIGS. 6 and 7. FIGS. 6 and 7 illustrate occurrence of predetermined events of a method for communication traffic management according to an embodiment of the present invention.

The electronic device 100, in the occurrence of a predetermined event, can carry out operation for managing communication traffic of a network.

The controller 150 can detect occurrence of a predetermined event through the input module 110. For example, a predetermined event may correspond to the case where the user inputs a signal requesting execution of an application for communication traffic management through the input module 110.

Also, the controller 150 can detect occurrence of a predetermined event in a network through the communication module 130.

At this point, a predetermined event can correspond to the case where the electronic device 100 connects to a network carrying out a multimedia service. For example, if the electronic device 100 approaches a network formed by a short range communication network, the electronic device 100 can detect a communication channel by detecting a multimedia device 200 included in the network, a network manager 300, or access points (APs) through the communication module 130; and connect to the network. To give another example, if the electronic device 100 connects to a wired communication network, the electronic device 100 can connect to the network by receiving an address from a network manager 300 managing the wired communication network or a gateway.

In the same way, the predetermined event can correspond to the case where communication resources for data communication carried out in a network become insufficient or an error has occurred. For example, as shown in FIG. 6, the predetermined event can correspond to the case of insufficient bandwidth for communication due to degradation of communication status, communication failure, or insufficient communication resources as multiple data communication is carried out at the same time while a multimedia device 200 is in the middle of carrying out data communication through short range wireless communication.

Also, the predetermined event can correspond to the case where a multimedia device 200 receives a request for carrying out another data communication while the multimedia device 200 is already carrying out data communication through the communication module 130. For example, FIG. 7 illustrates a case where a contents player already carrying out more than one streaming service receives a signal requesting execution of another streaming.

In this way, if occurrence of a predetermined event is detected, the controller 150 can output information notifying of occurrence of the predetermined event through the output module 120 and carry out operation for communication traffic management.

An electronic device 100 can obtain information about data communication carried out in a network S120.

The controller 150 can receive information about data communication carried out in a network from the network through the communication module 130. At this point, data communication carried out in a network can indicate transmitting and receiving contents carried out between multimedia devices 200 or between a multimedia device 200 and a contents server 400 belonging to an external network. The transmission and reception of contents can be interpreted as a concept including the types of streaming, uploading, downloading, progressive loading, and the like.

First, the controller 150 can obtain information about structure of a network.

For example, since information about structure of a network is stored previously in the storage unit 140, the controller 150 can recognize the network structure from the information stored in the storage unit 140.

To give another example, the communication module 130 can receive information about network structure from the network. The communication module 130 can receive identification information or address information of a multimedia device 100 belonging to the network from a network manager 300; the controller 150 can recognize network structure accordingly. Also, as the communication module 130 identifies each of multimedia devices 200 by carrying out communication with the respective multimedia devices 200 belonging to the network and receives the respective network addresses thereof, the controller 150 can recognize the network structure accordingly.

As described above, if the controller 150 obtains information about structure of a network, the controller 150 can receive information about data communication carried out in the network from the network through the communication module 130.

For example, when the network manager 300 is monitoring data communication carried out in the network, the communication module 130 can receive information about data communication from the network manager 300.

In another example, the communication module 130 carries out communication with each of multimedia devices 200 belonging to the network by using the obtained information about structure of the network, thereby receiving information about data communication carried out by the multimedia devices 200 directly from the multimedia devices 200.

At this time, information about data communication can include identification information or address information of a receiver-side multimedia device 200 and a transmitter-side multimedia device 200 associated with data communication; progress status of data communication reflecting whether data communication is in progress, suspended, completed, pending, or scheduled; transmission speed of data communication; priority assigned to data communication; communication specification whether data communication is carried out via Wi-Fi or Bluetooth; total communication resources for data communication and traffic status of communication resources occupied by current data communication; start time of data communication; elapsed time; estimated time up to completion; remaining time up to completion; type of data communication indicating whether data communication is streaming, uploading, downloading, or progressive downloading; a title of contents transmitted and received according to data communication; a file name and a representative image; resolution of contents; total size of contents; size of the contents transmitted; total playing time of the contents; current playing time; and playing time corresponding to the size of the contents transmitted. At this point, traffic status can reflect whether transmission of contents is carried out smoothly; for example, traffic status can be represented by a ratio of communication resources available to total communication resources or occupied ratio of communication resources according to current transmission and reception. Also, for example, if a multimedia device 200 is playing a moving image, an icon or text indicating “playing” can be displayed; in the case of transmitting a file, an icon or text representing “copying” or “moving” can be displayed.

An electronic device 100 can display connectivity relationship among multimedia devices 200 according to data communication S130.

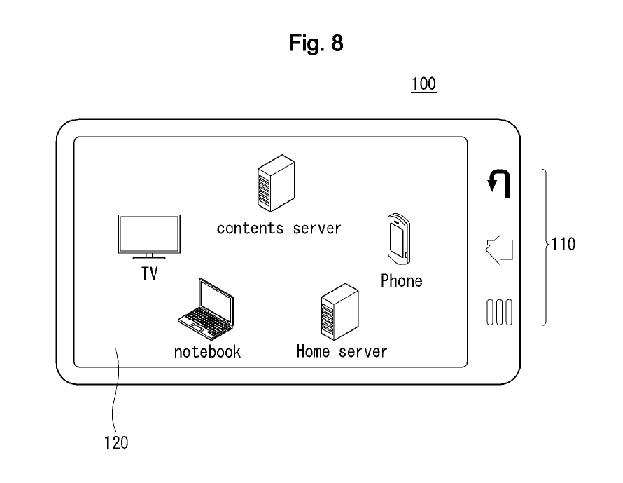

First, the controller 150 can display multimedia devices 200 belonging to a network on the output module 120. FIGS. 8 to 10 illustrate various embodiments of displaying multimedia devices 200 belonging to a network.

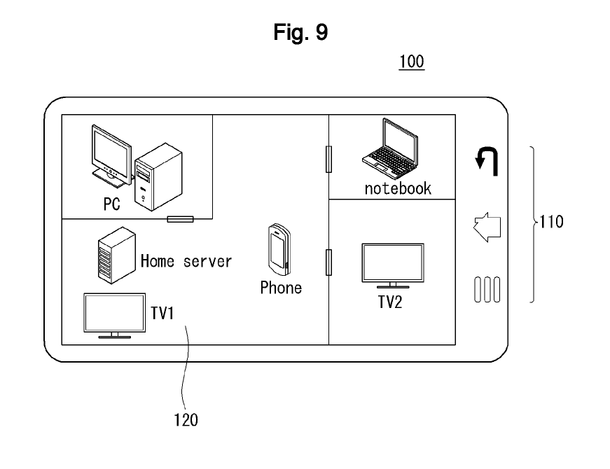

As shown in FIG. 8, the controller 150, with reference to information about network structure obtained as described above, can display multimedia devices 200 included in the network. At this time, the output module 120 can display a contents server 400 of an external network together. Individual multimedia device 200 can be displayed in the form of an icon or text. At this time, information about location where the corresponding multimedia device 200 is physically located can also be displayed. At the same time, as shown in FIG. 9, an indoor map can be displayed and a multimedia device 200 can be displayed at the corresponding position in the map reflecting the actual location of the multimedia device 200.

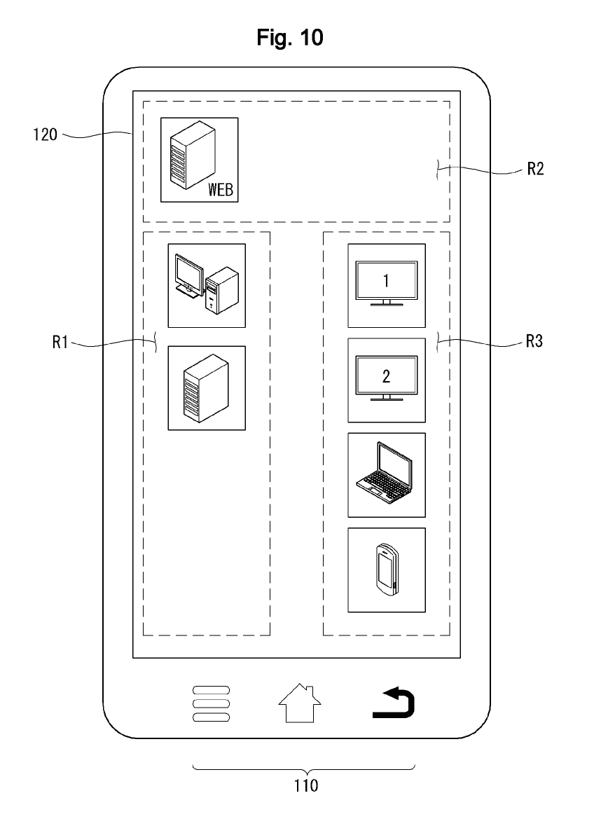

Also, when the controller 150 attempts to display multimedia devices 200, the controller 150 can display the multimedia devices 200 by classifying the multimedia devices 200 included in a network according to their types. As shown in FIG. 10, from the multimedia device 200, a contents source can be displayed in a first area R1 while a contents player can be displayed in a third area R3. At this time, the contents server 400 can be displayed in a first or a second area R1, R2. In a similar way, the controller 150 can display a device transmitting contents in the first area R1 and a device receiving contents in the second area R2.

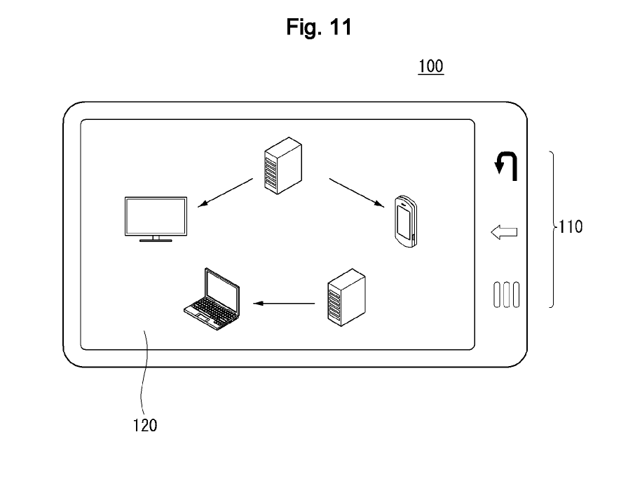

The controller 150, based on the information about data communication obtained as described above, can display connectivity relationship among multimedia devices 200. FIGS. 11 to 14 illustrate display of connectivity relationship among multimedia devices 299 of a method for communication traffic management according to an embodiment of the present invention.

If multimedia devices 200 belonging to a network area displayed as described above, connectivity relationship among them can be displayed based on information about data communication.

FIG. 11 displays connectivity relationship among multimedia devices 200 when the contents server 400 streams a first moving image to TV, a second moving image to a smart phone, and a third moving image is transmitted to a laptop computer from NAS.

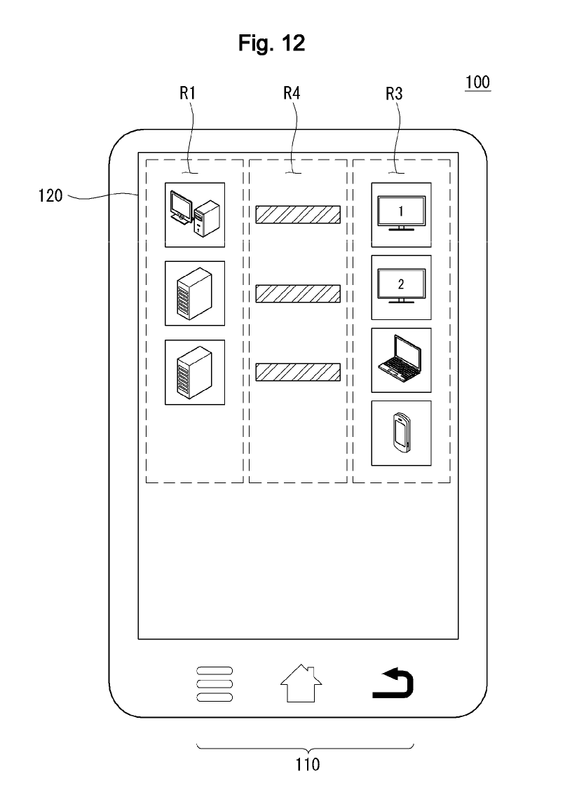

FIG. 12 displays connectivity relationship when a moving video is streamed from PC to a first TV and the moving image is transmitted from NAS to a second TV and a laptop computer. FIG. 12 displays connectivity relationship among multimedia devices 200 according to data communication; in the case of NAS, it is displayed multiply since it carries out multiple data communication. Also, the controller 150 can display a device transmitting contents in the first area R1, a device receiving contents in the third area R3, and relationship between the two in a fourth area R4.

At this point, a connectivity relationship can be displayed in the form of a graphic image connecting from a transmitter-side to a receiver-side multimedia device 200.

The graphic image can reflect traveling direction of data communication. For example, as shown in FIG. 11, the graphic image can reflect the direction of data communication by using an image of arrow shape, either in the form of an arrow image directing from a transmitter-side to a receiver-side or in the form of animation moving from the transmitter-side to the receiver-side.

Also, the graphic image can reflect progress status of data communication. For example, an animation can represent active data communication moving from the transmitter to the receiver while a still image can represent suspension of data communication. In another example, color of the graphic image can reflect progress status of data communication; if the color of the graphic image is green, it may represent data communication in progress while red color indicates suspension and blue color pending or scheduling.

Meanwhile, when multimedia devices 200 are displayed as described above, it does not necessarily have to display all of multimedia devices 200 included in a network.

For example, in the case of insufficient bandwidth for data communication, disconnection, occurrence of an error, or occurrence of an event that a multimedia device 200 carrying out data communication receives a request for another data communication, it would be sufficient to display only the related multimedia device 200. At the same time, a multimedia device 200 capable of replacing the related multimedia device 200 can also be displayed.

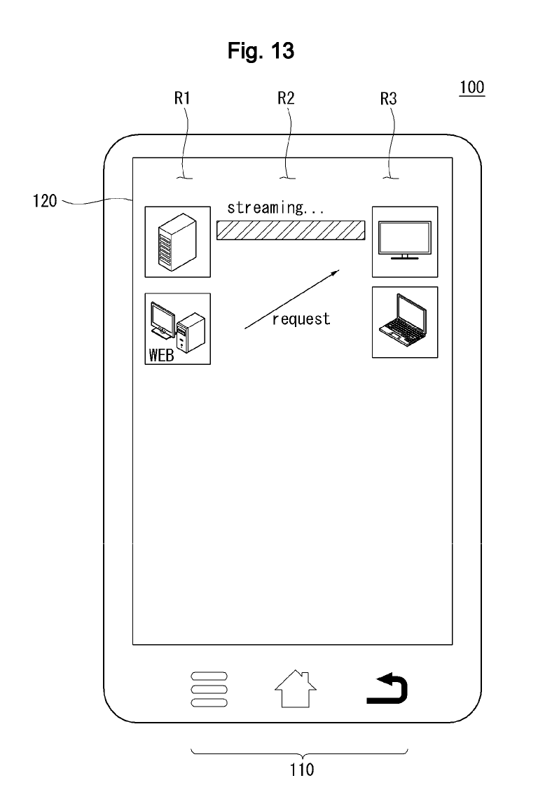

For example, as shown in FIG. 13, if a first TV receives a request for streaming of a second moving image from PC while the first TV is receiving a first moving image from the contents server 400, the output module 120 can display the first TV, the contents server 400, and PC. At the same time, the output module 120 can further display a second TV and a laptop computer capable of receiving a second moving image or a first moving image.

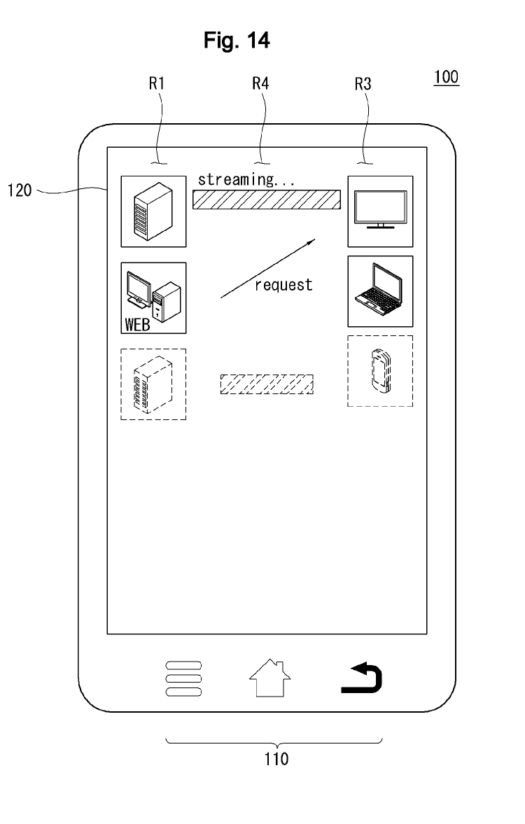

In this case, it does not necessarily have to display only the multimedia devices 200 but other multimedia devices 200 can also be displayed. At this time, multimedia devices 200 related to an event such as the first TV, the contents server 400, PC, the second TV, and the laptop computer can be displayed separately from the other multimedia devices 200. For example, as shown in FIG. 14, other multimedia devices 200 can be displayed in translucent color. Similarly, if a multimedia device 200 is carrying out data communication, a color icon corresponding to the multimedia device can be displayed; otherwise, a mono-color icon can be used.

In addition, data communication related to an event, namely, transmission of a first and a second moving image; connectivity relationship according to data communication for streaming; and other connectivity relationships can also be displayed separately.

Meanwhile, the output module 120 can display various kinds of information in addition to connectivity relationship among multimedia devices 200 included in a network and multimedia devices 200 according to data communication.

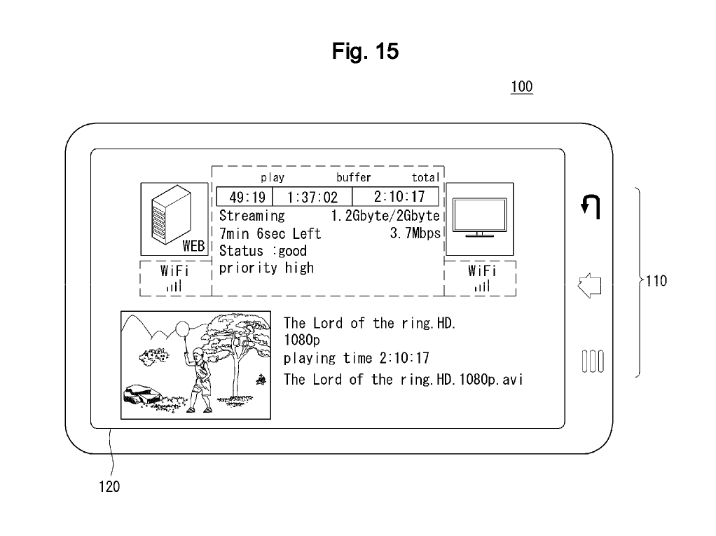

FIG. 15 illustrates display of information about contents communicated and data communication of a method for communication traffic management according to an embodiment of the present invention. For example, the output module 120, as shown in FIG. 15, can display at least one of identification information including at least one of data communication speed, priority, communication traffic status, communication type, time elapsed for data communication, estimated time up to completion, a title of contents communicated according to data communication, a file name, and a representative image; resolution of contents, total size of contents, size of contents transmitted, total playing time of contents, current playing time, and playing time corresponding to the size of the contents transmitted.

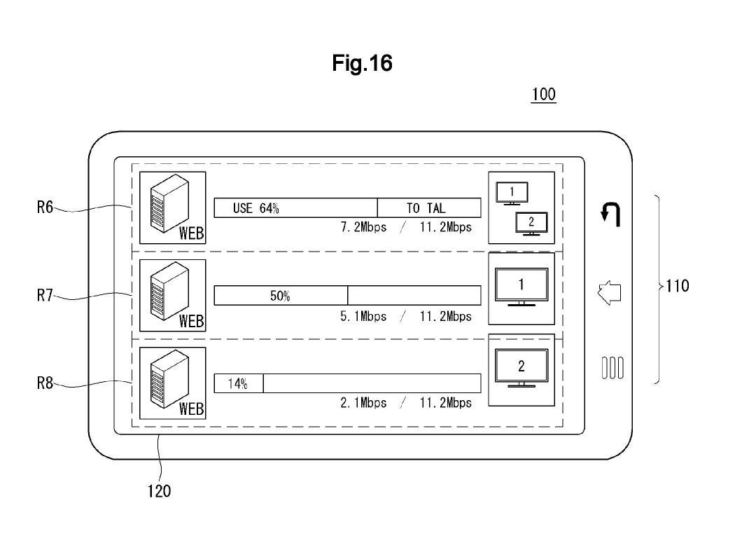

At this time, if a multimedia device 200 carries out multiple data communication, the output module 120 can display traffic status according to the multiple data communication separately or by summing the separate communication traffic. FIG. 16 illustrates display of communication traffic according to multiple data communication of a method for communication traffic management according to an embodiment of the present invention. As shown in FIG. 16, if the contents server 400 streams a first and a second moving image respectively to a first and a second TV, a sixth area R7 can display information about first data communication according to the first moving image; a seventh area R8 can display information about second data communication according to the second moving image; and an eighth area R6 can display a sum of traffic status according to the first and the second data communication.

An electronic device 100 can control data communication of a network S140.

The controller 150 can generate a control signal for controlling data communication of a network and transmit the signal through the communication module 130, thereby controlling multimedia devices 200 of the network and controlling data communication carried out the multimedia devices 200. The electronic device 100 can perform a direct remote control of multimedia devices 200 or control the multimedia devices 200 indirectly by controlling a network manager 300 so that the network manager can control the multimedia devices 200.

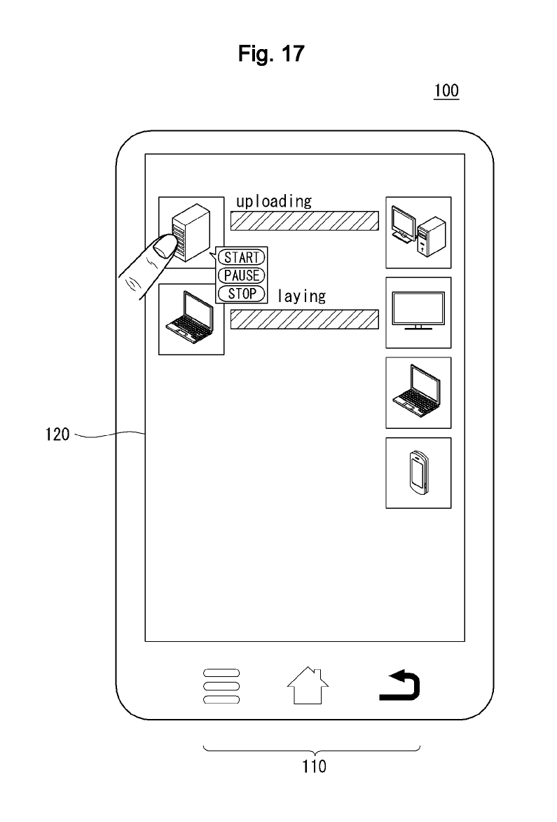

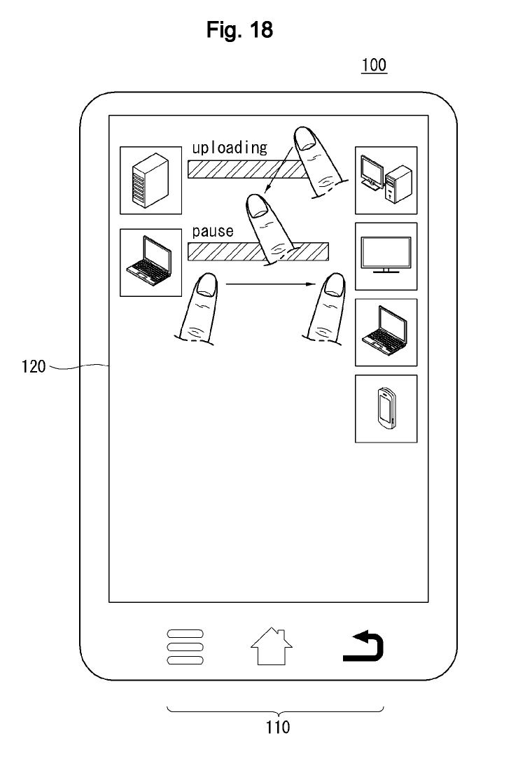

The controller 150 can control progress or suspension of data communication of a network. FIGS. 17 and 18 illustrate progress or suspension of data communication of a method for communication traffic management according to an embodiment of the present invention.

As shown in FIG. 17, the output module 120 displays multimedia devices 200 carrying out data communication, connectivity relationship among the multimedia devices 200, and information about data communication and contents. At this point, the output module 120 is a touch screen; if the user touches a graphic object reflecting multimedia device 200 or connectivity relationship, the controller 150 can display a menu through the output module 120, with which the user can select one from among progress, suspension, pending, and scheduling of data communication. Among these, the controller 150 can generate a control signal about data communication according to the input selected by the user; and control progress or suspension of data communication by transmitting the control signal to the multimedia devices 200 through the communication module 130.

Meanwhile, the controller, if a predetermined touch input is receive through the input module 110 which is a touch screen, can control progress or suspension of data communication according to the input. For example, as shown in FIG. 18, if a touch input along vertical direction is received, which touches the position at which displayed is a graphic object indicating connectivity relationship, the controller 150 can stop data communication corresponding to the connectivity relationship. In another example, if a touch input along horizontal direction is received, which touches a graphic object indicating the temporarily stopped data communication, the data communication can be restored. In a similar way, if a touch input is received moving from a transmitter-side multimedia device 200 to a receiver-side multimedia device 200, the temporarily stopped data communication can also be restarted.

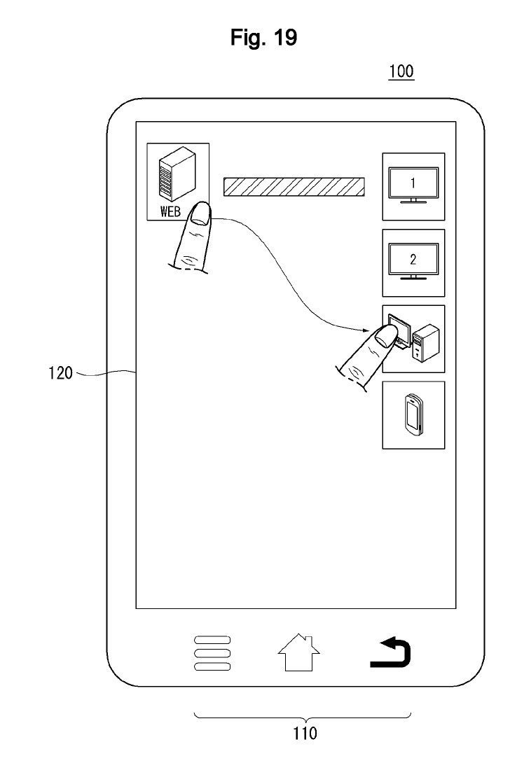

Also, the controller 150 can change multimedia devices 200 carrying out data communication. FIG. 19 illustrates replacement of a multimedia device 200 carrying out data communication of a method for communication traffic management according to an embodiment of the present invention.

The controller 150 can change at least one of a transmitter-side multimedia device 200 and a receiver-side multimedia device 200 carrying out data communication. If the controller 150 receives a multimedia device 200 carrying out data communication and multimedia trying to replace the multimedia device 200 through the input module 110, the controller 150 can change the multimedia device 200 carrying out data communication accordingly.

For example, as shown in FIG. 19, if streaming is in progress from a contents server 400 to TV1, if the user drags from the icon representing the contents server 400 to the icon representing PC, the controller 150 can change the streaming from the contents server 400 to TV1 to streaming to PC.

At this time, initially the output module 120 can only display the contents server 400 and PC; depending on the user's input, other multimedia devices 200 replacing the above can be displayed. For example, if the user makes a double touch on a graphic object representing the contents server 400, PC, or connectivity relationship, an icon indicating TV2, PC, a smart phone, etc. can be displayed.

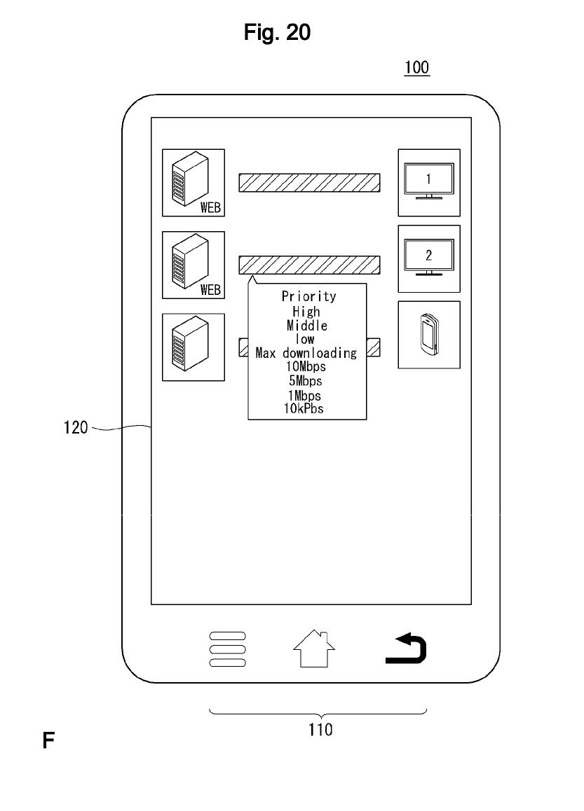

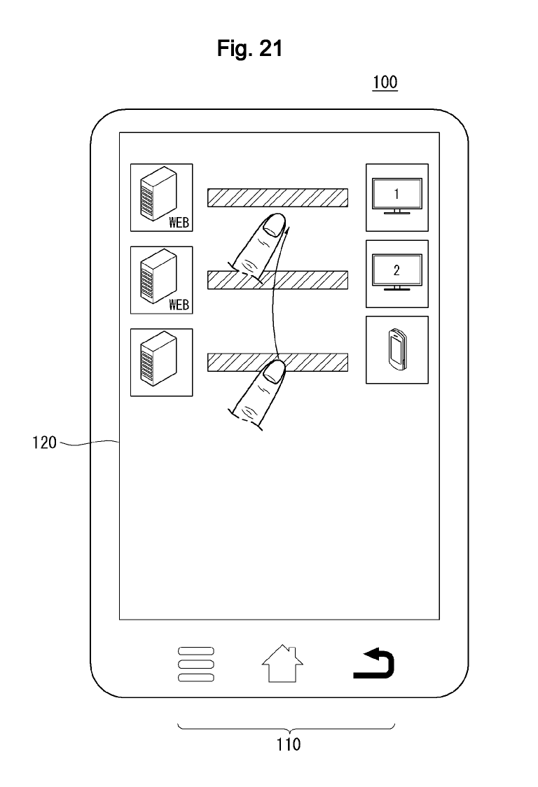

Also, the controller 150 can control execution order, priority, maximum communication speed of data communication, etc. FIGS. 20 and 21 illustrate execution order of carrying out data communication and control of maximum communication speed of a method for communication traffic management according to an embodiment of the present invention.

As shown in FIG. 20, the controller 150, if a graphic object representing a multimedia device 200 involved with data communication or connectivity relationship is touched, the controller 150 can display a menu about execution order, priority, maximum communication speed and the like and control data communication according to the user's touch input on the menu.

At this time, connectivity relationship about data communication or multimedia devices 200 can be arranged according to execution order or priority. In the example of FIG. 21, the streaming from the contents server 400 to a first TV is the first priority, while streaming to a second TV the second priority and data transmission from NAS to a smart phone the third priority; according to the order, multimedia devices 200 and connectivity relationship among them are displayed forming a hierarchy.

At this point, if bandwidth for data communication is insufficient, the controller 150 can control data communication of low priority to be suspended temporarily.

Meanwhile, the user can move an icon representing a multimedia device 200 related to particular data communication or connectivity relationship by dragging the icon, execution order or priority can then be changed according to the user's motion. For example, as shown in FIG. 21, if the user drags a graphic object of connectivity relationship representing data transmission of the third priority and drops the graphic object between the first and the second priority data communication, data transmission from NAS to a smart phone becomes the second priority while streaming from the contents server 400 to the second TV the third priority.

In a method for communication traffic management according to an embodiment of the present invention described in detail, steps comprising each embodiment are not necessarily required but each embodiment can include the aforementioned steps selectively. Also, steps comprising each embodiment do not necessarily have to be carried out according to the order described above; some steps described later can be carried out before the steps described earlier.

Also, in a method for communication traffic management according to an embodiment of the present invention, the respective embodiments can be used separately or in combination with each other. Furthermore, steps comprising each embodiment can be used individually or in combination with the steps comprising other embodiments.

In addition, a method for communication traffic management according to an embodiment of the present invention can be stored in a computer-readable recording medium in the form of codes or a program carrying out the method.

The present invention described above allows various substitutions, modifications, and changes without escaping the technical principles of the present invention by those skilled in the art to which the present invention belongs; therefore, the present invention is not limited by the embodiments above and appended drawings. Also, embodiments described in this document are not intended for limited applications; but, to allow various modifications, all or part of the embodiments can combine with each other selectively and form another one.

### DESCRIPTION OF SYMBOLS

100: electronic device 110: input module 120: output module
130: communication module 140: storage module 150: controller
200: multimedia device 300: network manger 400: contents server

### ADVANTAGEOUS EFFECTS OF THE INVENTION

According to an embodiment of the present invention, by displaying connectivity relationship among multimedia devices according to data communication, the user can recognize data communication carried out in a network.

According to an embodiment of the present invention, by controlling data communication carried out in a network, the user can manage communication traffic of a network.

Advantageous effects of the present invention are not limited to those described above; other effects not described above would be clearly understood by those skilled in the art to which the present invention belongs from the description in this document.

What is claimed is:

1. An electronic device, comprising:
a communication module;
a display; and
a controller configured to:
obtain information about data communication carried out in a network through the communication module from the network providing multimedia services; and
display a plurality of multimedia devices connected to the network and connectivity relationship among the multimedia devices according to the data communication through the display, the connectivity relationship being related to at least one of the multimedia devices communicating multimedia data with at least one other multimedia device.

2. The electronic device of claim 1, wherein the controller carries out the display operation if communication resources for data communication carried out in the network are insufficient.

3. The electronic device of claim 1, wherein the controller carries out the display operation if a multimedia device carrying out the data communication receives a request to carry out different data communication.

4. The electronic device of claim of 3, wherein the controller controls the display to display the multimedia device to be distinguished from the other multimedia devices; or to display connectivity relationship according to at least one of data communication carried out by the multimedia device and the different data communication to be distinguished from the other connectivity relationships.

5. The electronic device of claim 1, wherein the controller receives information about data communication through the communication module from a network manager managing the network.

6. The electronic device of claim 1, wherein the controller receives information about the data communication through the communication module from each of the multiple multimedia devices.

7. The electronic device of claim 1, wherein the controller displays the connectivity relationship through the display by using a graphic link connecting a transmitter-side multimedia device and a receiver-side multimedia device of the data communication.

8. The electronic device of claim 7, wherein the graphic link connecting the multimedia devices reflects at least one of progress status indicating either progress or suspension of the data communication; and progress direction.

9. The electronic device of claim 1, wherein the controller displays at least one of speed, priority, communication traffic status, communication type of the data communication, time elapsed for the data communication, and estimated time up to completion of the data communication through the display.

10. The electronic device of claim 1, wherein the data communication corresponds to data communication about transmission and reception of contents; and transmission and reception of the contents includes at least one of streaming, uploading, download, and progressive downloading of the contents.

11. The electronic device of claim 10, wherein the controller displays at least one of a title of the contents; identification information including at least one of a file name and a representative image of the contents; resolution of the contents; total size of the contents; size of the contents transmitted; total playing time of the contents; and current playing time and playing time corresponding to the size of the contents transmitted.

12. The electronic device of claim 1, wherein the controller controls data communication carried out in the network.

13. The electronic device of claim 12, wherein the controller controls progress or suspension of the data communication.

14. The electronic device of claim 12, wherein the controller replaces either of a transmitter-side multimedia device and a receiver-side multimedia device of the data communication with another multimedia device.

15. The electronic device of claim 12, wherein the controller controls at least one of execution order and maximum communication speed of the data communication.

16. The electronic device of claim 1, wherein the controller further displays connectivity relationship among a contents server external to the network and the multimedia devices through the display.

17. The electronic device of claim 16, wherein the controller displays communication traffic caused by data communication among the contents server and the multimedia devices separately or by summing the separate communication traffic.

18. The electronic device of claim 16, wherein at least two connectivity relationships are displayed.

19. A method for communication traffic management, comprising:
obtaining, from a network providing a multimedia service, information about data communication carried out in the network; and
displaying connectivity relationship among a plurality of multimedia devices connected to the network and multimedia devices according to the data communication, the connectivity relationship being related to at least one of the multimedia devices communicating multimedia data with at least one other multimedia device.

20. The method of claim 19, wherein when communication resources for data communication carried out in the network are insufficient, the displaying step is carried out.

21. The method of claim 19, wherein when a multimedia device carrying out the data communication is requested to carry out different data communication, the displaying step is carried out.

22. The method of claim 19, wherein information about the data communication is received from a network manger managing the network or each of the multiple multimedia devices.

23. The method of claim 19, wherein the connectivity relationship is displayed by suing graphic links connecting transmitter-side multimedia devices and receiver-side multimedia devices of the data communication.

24. The method of claim 23, wherein the graphic link connecting the multimedia devices reflecting progress status representing either progress or suspension of the data communication.

25. The method of claim 19, further comprising displaying at least one of speed, priority, communication traffic status, communication type of the data communication, time elapsed for the data communication, and estimated time up to completion of the data communication.

26. The method of claim 19, the data communication corresponding to data communication about transmission and reception of contents; and further comprising:
displaying at least one of a title of the contents; identification information including at least one of a file name and a representative image of the contents; resolution of the contents; total size of the contents; size of the contents transmitted; total playing time of the contents; and current playing time and playing time corresponding to the size of the contents transmitted.

27. The method of claim 19, further comprising controlling data communication carried out in the network.

28. The method of claim 27, wherein the controlling step comprises at least one of controlling progress or suspension of the data communication; replacing either of a transmitter-side multimedia device and a receiver-side multimedia device of the data communication with another multimedia device; and controlling at least one of execution order and maximum communication speed of the data communication.

29. The method of claim 19, wherein at least two connectivity relationships are displayed.
